(19) United States
(12) Patent Application Publication
(10) Pub. No.: US 2022/0345589 A1
(43) Pub. Date: Oct. 27, 2022

(54) COLOR MATCHING FOR PRINTS ON COLORED SUBSTRATES

(71) Applicant: HEWLETT-PACKARD DEVELOPMENT COMPANY, L.P., Spring, TX (US)

(72) Inventors: Peter Morovic, Sant Cugat del Valles (ES); Jan Morovic, London (GB)

(21) Appl. No.: 17/753,791

(22) PCT Filed: Sep. 20, 2019
(86) PCT No.: PCT/US2019/052152

§ 371 Date: Mar. 15, 2022

(51) Int. Cl. H04N 1/60; H04N 1/52; G01J 3/46

(52) U.S. Cl. CPC H04N 1/6097; H04N 1/52; H04N 1/6058; G01J 3/462

(57) ABSTRACT

Examples of a method and a system measure colorimetric data of a set of color samples deposited on a reference substrate and on at least one further substrate having distinct colors from one another. Based on the measured colorimetric data, estimate functions are applied for mapping between the colorimetric data of the color samples deposited on differently colored substrates.

### BACKGROUND OF THE INVENTION

When printing an image on a colored print substrate such as dyed textiles, the color as perceived by the human eye, which is also referred to as the colorimetry, of the printout may be affected by the color of the substrate. Moreover, the entirety of colors that is reproducible by a given printing process or printing device, which is also referred to as the respective gamut, may also depend on the color of the substrate.

### BRIEF DESCRIPTION OF THE DRAWINGS

FIG. 1 is a schematic view of a printing system according to an example;

FIG. 2 is a flow diagram of a method according to an example;

FIG. 3 shows diagrams showing measured colorimetric data of a set of color samples deposited on a reference substrate and on differently colored further substrates in a color space according to an example;

FIG. 4 is a flow diagram of a method according to an example; and

FIG. 5 shows diagrams of colorimetric data according to an example.

### DESCRIPTION OF THE PREFERRED EXAMPLES

In the following, examples of a method and system are described that may allow for predicting the appearance of different colors on any given colored substrate. The examples of a method and system may allow for predicting the colorimetry of an image if printed on at least one colored substrate. The examples of a method and system may allow for determining whether and how accurately an input image may be printed on a substrate having a particular color. The examples of a method and system may allow for controlling color settings of a device for printing an input image on a substrate having a particular color. The examples of a method and system may allow for management of the color settings taking into account the colors of an image to be printed and the color of a respective substrate on which the image is to be printed. The color settings may be adjusted individually in accordance with the respective image and the color of the respective substrate. This may facilitate finding an optimized match for each color of an input image to be reproduced. The subject matter of the present disclosure may provide an accurate model for characterizing and profiling colored substrates. This may allow for predicting the colorimetry of printouts on differently colored substrates.

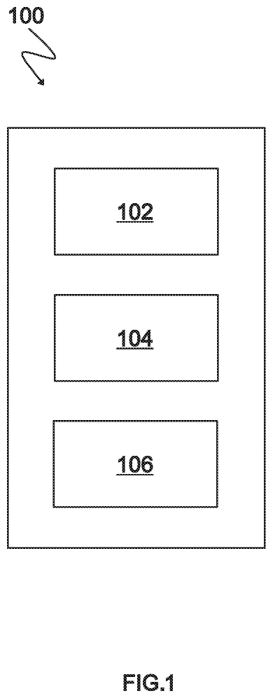

FIG. 1 shows a schematic view of a printing system 100 according to an example. The printing system 100 may comprise a deposition device 102, a measurement device 104 and a computing device 106. The printing system 100 may be provided as a single device, for example as a printing device. In other examples, the printing system may comprise a printing device, and at least one of the deposition device 102, the measurement device 104 and the computing device 106 may be part of a printing device. Further, any of the deposition device 102, the measurement device 104 and the computing device 106 may be partially included in a printing device. In a specific example, the printing device may comprise, or be part of, the deposition device 102.

The deposition device 102 may deposit a set of color samples on a reference substrate having a reference color. Further substrates may be provided having colors distinct from one another and distinct from the reference color of the reference substrate.

The deposition device 102 may further deposit the set of color samples on each of the further substrates. The deposition device 102 may comprise, or be part of, a printing device (not shown).

The measurement device 104 may measure colorimetric data of the color samples deposited on the reference substrate. The measurement device 104 may further measure colorimetric data of the color samples deposited on the further substrates. The measurement device 104 may comprise a spectrometry device. For example, measurement device 104 may perform the measurement of the colorimetric data according to tristimulus colorimetry, spectroradiometry, spectrophotometry, spectrocolorimetry, densitometry, color temperature, or the like or any combination thereof. The colorimetric data may include any of reflectance spectra, tristimulus values, transmittance spectra, and relative irradiance spectra. In particular, the colorimetric data may be reflection intensities measured at distinct wavelengths in the visible wavelength range, which may range approximately between 350 nm and 750 nm, or between 400 nm and 700 nm.

The computing device 106 may provide, for each of the further substrates, a respective estimate function to estimate mapping of reference colorimetric data to respective further colorimetric data. This may correspond to any of the forward mapping, forward matrix, or forward function as discussed in the present disclosure. Additionally or alternatively, the computing device 106 may provide, for each of the further substrates, a respective, estimate function to estimate mapping of the respective further colorimetric data to the reference colorimetric data. This mapping may correspond to any of the reverse mapping, reverse matrix, or reverse function as discussed herein.

The computing device 106 may be provided as a physical device. Additionally or alternatively, the computing device 106 may include instructions that can be executed by a processing unit to carry out any of the operations as discussed herein. In particular, the instructions may be executable by a processing unit to at least one of derive, calculate, determine and apply the estimate function as discussed herein.

Examples of a method are discussed in the following. The examples of a method, or its variation, may be carried out at least partially, and for example entirely, by the printing system too. Details of the functionalities of the printing system 100 and its components 102-106 may become apparent in connection with the examples of the method. In particular, terms and expressions used with reference to the printing device too may be further discussed in detail in connection with the examples of the method.

According to some examples, the examples of a method and system of the present disclosure allow for calculating a model from an initial measurement and a corresponding initial characterization of a particular colored substrate. The number of printing and measurement for the purpose of characterization and profiling of a particular colored substrate may be reduced to a single sample substrate. As such, the subject matter of the present disclosure may reduce the overhead for characterization and profiling for a given colored substrate.

In the present disclosure, any terms and expressions related to colors may refer to the respective colors as perceived by the human eye. The perception of colors by the human eye may be parametrized and quantified according to the established teachings of colorimetry. For example, the terms and expressions as used herein that are related to colors may be defined in accordance with any of the established colorimetry standards, such as CIE76 , CIE94, CIEDE2000, CMC I:c, etc. Accordingly, the expression of colors being different or distinct from one another may refer to these colors being distinguishable by the human eye and, additionally or alternatively, may be defined according to the common color science. For example, two colors being different or distinct from each other may refer to a delta E value according to CIEDE2000 therebetween being at least 1.

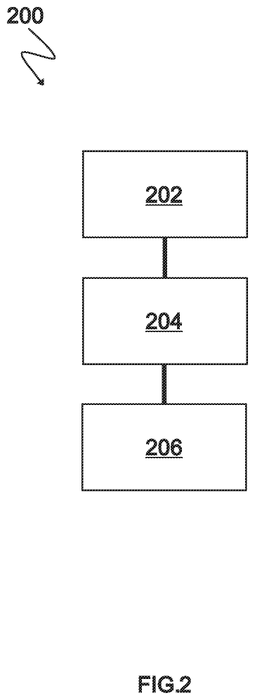

FIG. 2 shows a flow diagram of a method 200 according to an example. The method 200 may be carried out, at least partially or entirely, by the printing system too discussed with reference to FIG. 1. The method may include at least one of determining and providing a set of color samples, which herein will also be referred to as the color to samples. Prior to deposition on a substrate, the color samples may refer to distinct colors. After deposition on a substrate, the color samples may refer to optically detectable physical areas having a respective color. The color samples may be defined according to their colors with reference to a reference substrate, for example an achromatic substrate exhibiting a good reflectance substantially equally in all three tristimulus regions. Such a substrate may be perceived by the human eye as white or near-white. For example, the color samples may be determined such that their colors are as widely and evenly distributed against a neutral background (e.g. white or near-white) in a particular color space, such as L*a*b*.

In the present disclosure, for the sake of simplicity, white is referred to as a color. The color white may be defined according to any of the established standards as discussed above. Unless otherwise indicated, the expression white may be used herein as commonly understood or colloquially used. As such, a white substrate may refer to a neutral substrate that is uncolored, i.e. without coloring treatment or dyeing. In some contexts, a white substrate may be referred to as a blank substrate. In some examples as discussed herein, white may be used as a reference color. The term white as used herein may not be limited to an ideal white, which is achromatic and without hue, but also include white tones created by additively mixing colored light sources that are perceived by the human eye as white. As such, white may cover a non-zero area within a color space, and any color within this area may be considered as white. Such slight variations from the ideal white may also be referred to as near-white colors. The terms white or near-white may include colors which have approximately same distances to the primary colors of an additive color space.

The color samples may be defined in accordance with a known standard. For example, the color samples may include colors that are distinct from one another according to CIEDE2000 as established by the International Commission on Illumination (CIE). The color samples may be determined according to standard lookup-table targets in a RGB or CMYK color space. In some examples, the color samples may be obtained by dissecting a color space, for example by sampling along each of the main color axes, such as red, green and blue in a RGB color space, in a regular manner by a fixed integer N, thereby obtaining N^{∧}3 color samples. In some examples, the integer N may be 17, 25 or 33 in a RGB color space, thereby obtaining N^{∧}3 color samples. In further examples, the integer N may be 5, 7 or 9 in a CYMK color space, thereby obtaining N^{∧}4 color samples. In a specific example, some of the color samples may be obtained by sampling 7 times along each of the main axes of a RGB color space, resulting in 7^{∧}3=343 color samples. Additionally or alternatively, any known chart may be applied to obtain the color samples, an example of which is ECI 2002 target established by the European Color Initiative.

According to some examples, the color samples are predefined halftone colors available to a printing device. The term halftone as used in the present disclosure may be in line with the understanding from the common printing technology. As such, halftone may refer to a reprographic technique, or an image produced by employing this technique, that simulates continuous-tone imagery through the use of dots, varying either in size or spacing, thus generating a gradient-like effect. For example, the density of spot colors, such as cyan, magenta, yellow and black, may be varied in size or spacing to reproduce a particular shade. The spot colors may be deposited in a respective pattern, and the patterns of the spot colors may be rotated in relation to one another. The expression halftone colors may include all of the spot colors and the process colors that are producible by combining the spot colors. The halftone colors being available to a printing device may refer to being reproducible by the printing device using its spot colors.

Additionally or alternatively, the color samples may be determined according to individual requirements of a particular printing task or a particular printing device. For example, the color samples may include a predefined set of different skin tones. This may for example increase the applicability for imaging human skin. Additionally or alternatively, the color samples may include different neutral tones.

In some examples, the number of color samples may be between 10² and 10⁸. In other examples, the number of color samples may be between 10² and 10⁶, or 10² and 10⁵, or 10² and 10⁴ , or around 10³ , such as between 500 and 5000. It is appreciated that providing a sufficient number of color samples may allow for obtaining reliable results. However, providing an excessive number of color samples may unduly increase the requirements to carrying out the subject matter of the present disclosure particularly regarding computing power and data storage capacity. The number of the color samples may depend on the individual requirements of a particular printing task or a particular printing device. The number of the color samples may further depend on specific estimate functions to be applied as discussed herein. The number of the color samples may be at least partially determined empirically, and for example take into account training processes.

The method may include depositing the color samples on a variety of substrates. The substrates may comprise, or be made of, paper, textile, latex, polymer or the like or a combination thereof. The expression of depositing a color sample may refer to printing the same. The method and apparatus involved in depositing the color samples on a substrate may be various according to the common techniques and may for example include halftone printing. In particular, the deposition of the color samples may employ spat colors and process colors created by using the spot colors. The expressions depositing, deposition and printing may be used herein interchangeably.

When deposited, the color samples may each form an area extending along the surface of the substrate. As such, the color samples deposited on a substrate may each form a dot, patch, region, zone, field or the like. The deposited color samples may have a substantially circular, elliptical or polygonal shape or any combination thereof. Being physically deposited, the color samples may also extend in a direction perpendicular to the surface of the substrate.

The substrates may have different colors. The substrates may include at least one dyed substrate, which may also be referred to as a dye-ground. In the present disclosure, the expressions colored or dyed, if applicable to the respective substrate, may be used interchangeably. Depending on the colors of the substrates, the colors of the color samples deposited on the substrates may appear differently, i.e. may be perceived differently by the human eye.

A reference substrate may be provided in addition to the substrates, or one of the substrates may be designated as the reference substrate. The color of the reference substrate may be referred to as a reference color. The reference color may be white as discussed above. In other examples, the reference color may include, for example, red, green, blue, cyan, magenta, yellow, brown or orange. In these examples, the reference substrate may be a colored substrate, wherein the expression “colored” in this context indicates that the respective color is distinguishable from white and may be used interchangeably with non-white in this specific context.

At 202, colorimetric data of the color samples that are deposited on the reference substrate may be measured. The colorimetric data may refer to data quantifying and physically-mathematically describing a respective color as perceived by the human eye. In the present disclosure, the terms color, colorimetry and colorimetric data are connected to the same concept and may be used interchangeably for the sake of conciseness. The colorimetric data may be determined in accordance with any of the established standards, for example by any known CIE standard. In particular, the colorimetric data may consider physical correlates of the color perception, for example in terms of CIE1931 XYZ color space tristimulus values. The colorimetric data may be obtained through measurement techniques such as tristimulus colorimetry, spectroradiometry, spectrophotometry, spectrocolorimetry, densitometry, color temperature, or the like or any combination thereof. The colorimetric data may include any of reflectance spectra, tristimulus values, transmittance spectra, and relative irradiance spectra. In some examples, the colorimetric data may be reflection intensities measured at distinct wavelengths in the visible wavelength range (e.g. between 350 nm and 750 nm, or between 400 nm and 700 nm). As such, the reference colorimetric data may indicate the respective color of the color samples deposited on the reference substrate.

According to some examples, the reference colorimetric data may include any of: reflectance spectra, tristimulus values, transmittance spectra, and relative irradiance spectra. The data may directly or indirectly (e.g. inversely or reciprocally or in any derivable way) include reflectance, transmittance radiance intensities or a combination thereof at certain wavelengths. For example, the colorimetric data may include including reflectance intensity values measured at different wavelengths. The colorimetric data may be provided as a data set including the intensity values as entries. The colorimetric data may be arranged in a data array including the intensity values as entries. For example, the colorimetric data may be provided as a vector, a tuple or the like, including the intensity values as entries. The term intensity values may indicate the quantified value of the corresponding intensity. The intensity values may be provided as absolute values in a physical unit. Additionally or alternatively, the intensity values may be provided as relative values normalized to a reference intensity, such as an incident light intensity or a measurement light intensity. For the sake of the simplicity, the expressions intensity values and intensities may be used interchangeably herein unless indicated otherwise.

According to some examples, the reference colorimetric data may each contain reflectance intensities measured at distinct wavelengths within the visible wavelength range. In such examples, the method may further comprise providing the reference colorimetric data as S×R matrices. In a S×R matrix, S may indicate a first dimension of the matrix and represent the number of the color samples. For example, the first dimension to S may indicate an index or a list of the color samples. As such, the first dimension S may allow for identifying the individual color samples. R may indicate a second dimension and represent the number of the distinct wavelengths at which the reflectance intensities are measured. The number R may be between 3 and 10³. In some examples, the number R may be between 3 and 100, between 3 and 50, or around 20. In specific examples, the number R may be 16, 31 or 81. The distinct wavelengths may be determined by a fixed interval, for example by sampling at every 5 nm, every 10 nm, or every 20 nm within the visible wavelength range. It is understood that the wavelengths at which the reflectance intensities are measured in a real-world system each may refer to a certain wavelength range instead of being limited to a single wavelength value.

In a specific example, 1000 color samples may be determined comprising: color samples obtained from sampling the color space in a regular manner as described above, color samples corresponding to distinct tones of the human skin, and specific colors according to a particular colorimetric standard. The color samples may be deposited on a white reference substrate. The reflectance intensities of the color samples deposited on the reference substrate may be measured at 20 different wavelengths within the visible wavelength range by means of any spectrometer or colorimeter mentioned above. Accordingly, the reference colorimetric data of the color samples deposited on the reference substrate are obtained as a data set including 1000×20 intensity values.

At 204, further colorimetric data of the set of color samples that are deposited on at least one further substrate may be measured. As discussed above, the further substrates may have a respective color. Multiple further substrates may have further colors that are different from one another. The respective color of the at least one further substrate may be distinct from the reference color.

For the sake of the conciseness and readability, the at least one further substrate may also be referred to as the further substrates without excluding the case of using one single further substrate, unless indicated otherwise. In the present disclosure, the expression “respective” further colorimetric data may refer to the further colorimetric data corresponding to (or associated with) each one of multiple further substrates unless indicated otherwise. In the present disclosure, the reference colorimetric data and the further colorimetric data may be referred to as (the) colorimetric data in a combined manner for the sake of simplicity, unless indicated otherwise. In the present disclosure, the reference and respective further colorimetric data of the color samples deposited on one of the reference and one of the further substrates, respectively, may be referred to as colorimetric data corresponding to the respective substrate, for the sake of simplicity.

The further colorimetric data may be determined, measured or provided as described above with respect to the reference colorimetric data. Any of the above described with respect to the reference colorimetric data may apply to any of the further colorimetric data as well.

According to some examples, any of the further colorimetric data may include any of: reflectance spectra, tristimulus values, transmittance spectra, and relative irradiance spectra. The data may directly or indirectly (e.g. inversely or reciprocally or in any derivable way) include reflectance, transmittance radiance intensities or a combination thereof at certain wavelengths. For example, the colorimetric data may include including reflectance intensity values measured at different wavelengths. The colorimetric data may be provided as a data set including the intensity values as entries. The colorimetric data may be arranged in a data array including the intensity values as entries. For example, the colorimetric data may be provided as a vector, a triple or the like, including the intensity values as entries. The term intensity values may indicate the quantified value of the corresponding intensity. For the sake of the simplicity, the expressions intensity values and intensities may be used interchangeably herein unless indicated otherwise.

According to some examples, any of the further colorimetric data may each contain reflectance intensities measured at distinct wavelengths within the visible wavelength range. In such examples, the method may further comprise providing any of the further colorimetric data as S×R matrices. In a S×R matrix, S may indicate a first dimension of the matrix and represent the color samples; and R may indicate a second dimension and represent the distinct wavelengths at which the reflectance intensities are measured. In particular, any of the further colorimetric data may have the same dimension or the same dimensions as the reference colorimetric data as discussed above.

Referring to the specific example discussed above, the 1000 color samples may be deposited on any of the further substrates. The reflectance intensities of the color samples deposited on any of the further substrates may be measured at the 20 different wavelengths within the visible wavelength range as discussed above. Accordingly, the further colorimetric data of the color samples deposited on any of the further substrates are obtained as data sets each including 1000×20 intensity values. In such examples, the further colorimetric data may each have the same dimension or the same dimensions as to the reference colorimetric data as discussed above.

Any other arrangement is contemplated for any of the reference colorimetric data and the further colorimetric data. For example, the dimensions may be inversed, resulting in R×S matrices instead of S×R matrices in other examples, any of the reference and further colorimetric data may be arranged in a single column or single row resulting in S times R vectors. The structure of the colorimetric data may be altered or modified according to the individual requirements of a particular task or a particular system. Unifying the dimension or dimensions of both the reference colorimetric data and the further colorimetric data may facilitate further processing of the reference and further colorimetric data.

As discussed above, the colorimetry of the color samples deposited on the further substrate may differ from the colorimetry of the color samples deposited on the reference substrate. For example, yellow and yellowish color samples deposited on a white or near-white reference substrate may appear yellow and yellowish, respectively, while their color may be distorted when deposited on a blue substrate or a red substrate. Generally, the colorimetry of the color samples may be shifted towards the respective color of the substrates on which they are deposited.

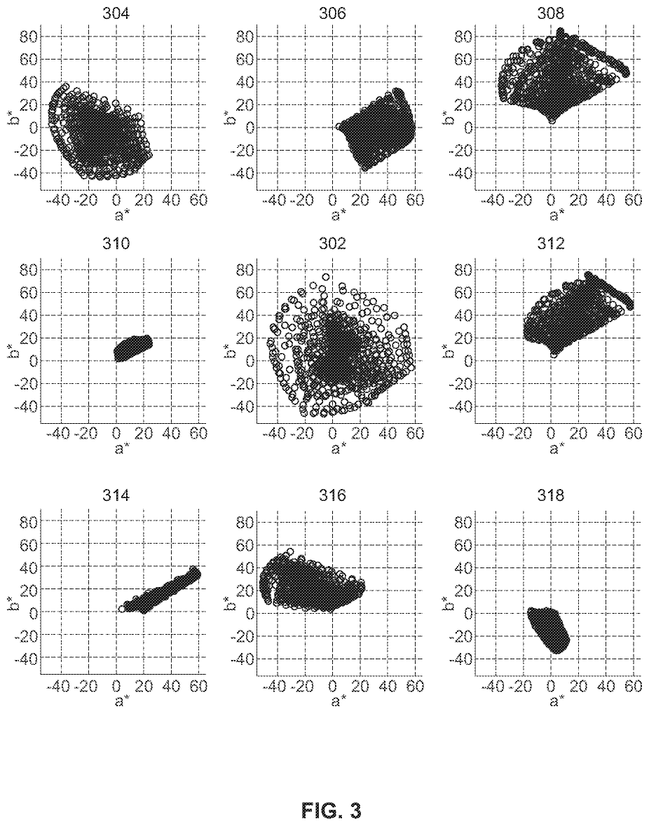

FIG. 3 shows measured colorimetric data of a predefined set of color samples deposited on a white reference substrate and on differently colored further substrates in a L*a*b* color space, wherein the axes a* and b* are shown. A diagram 302 at the center of FIG. 3 shows the measured colorimetric data of the predefined set of color samples deposited on a white reference substrate diagrams 304, 306, 308, 310, 312, 314, 316 and 318 show the measured colorimetric data of the same predefined set of color samples deposited on a cyan, magenta, yellow, brown, orange, red, green and blue substrate, respectively.

Each dot in the diagrams 302-318 of FIG. 3 represents the color of a single color sample in the (L*)a*b* color space. The a* axis represents a color gradient from green (negative) to red (positive). The b* axis represents a color gradient from blue (negative) to yellow (positive). The L* axis represents lightness from black (zero) to white (100). The diagrams 302-318 of FIG. 3 display a two-dimensional projection of the color space onto the a*-b*-plane. The dots in FIG. 3 are arbitrarily enlarged for the sake of visualization of their positions and may not represent their respective color spectrum inside to the color space.

FIG. 3 demonstrates that the distribution of the color samples densifies when deposited on colored substrates in comparison to a comparably wide distribution within the color space when deposited on the white substrate. It becomes apparent that the colorimetry of the color samples densifies and shifts towards the respective color of the substrates when compared to the white reference substrate in the diagram 302. For example, the color samples deposited on the green substrate in diagram 316 are densified on a negative side of the a* axis, which corresponds to green. Similarly, the color samples deposited on the yellow and orange substrates in diagrams 306 and 310 are densified on a positive side of the b* axis, which corresponds to yellow.

It is hence demonstrated that the colorimetry of the color samples varies depending on the color of the substrate on which the color samples are deposited. Since the color samples of FIG. 3 are chosen to cover a wide area within the perceivable color space, such a distortion of colorimetry may also occur when printing a colored image on a colored substrate. Therefore, mapping the colorimetry that is employed in a given colored image to the colorimetry of a target substrate may increase the accuracy of the printing process. In the present disclosure, the target substrate may refer to a substrate on which an input image is to be printed, wherein the input image is a colored image and the target substrate is a colored substrate.

Referring back to FIG. 2, the method 200 at 206 applies a respective estimate function for each of the at least one further substrate to map the reference colorimetric data to the respective further colorimetric data. Such an estimate function may be referred to as a forward mapping. Additionally or alternatively, the respective estimate function is applied for each of the at least one further substrate to map the respective further colorimetric data to the reference colorimetric data. Such an estimate function may be referred to as a reverse mapping.

In the present disclosure, the expression of mapping one colorimetric data to other colorimetric data may refer to determining relationships therebetween. The mapping may include establishing a reproduction of each of the color samples in differently colored substrates. The mapping may include any of a logical connection, mathematical relation, lookup table, empirical connection or any combination thereof.

The estimate function as used herein may refer to a reproducible set of rules for determining relationships between the reference colorimetric data and the respective further colorimetric data. The estimate function may include any of a logical connection, mathematical relation, lookup table, empirical connection or any combination thereof.

According to some examples, the estimate function may be provided by applying at least one of a regression analysis and supervised learning. In the present disclosure, regression analysis may refer to a set of statistical processes for estimating relationships among variables e.g. by modelling and analyzing the same. A starting parameter may be determined as an independent variable (or a “predictor”), and a target parameter may be determined as a dependent variable (or a “criterion variable”); the regression analysis may be applied to establish a relationship therebetween. As such, the regression analysis may establish a rule, or a function, to estimate how the value of the dependent variable changes in response to a change of the independent variable. The regression analysis or the supervised learning may be performed for each color sample to map its reference colorimetric data to its respective further colorimetric data and vice versa.

The regression analysis may involve any known regression techniques from the teachings of the statistics. Examples of the regression techniques may include: linear or nonlinear regression models with the respectively underlying assumptions, regression diagnostics, error estimation, calculation at least one of a linear least square, nonlinear least square and weighted least square. Additionally or alternatively, the regression analysis may employ a Bayesian method, percentage regression, least absolute deviations, nonparametric regression, scenario optimization, interval predictor model, distance metric learning, etc.

The regression analysis may employ any known regression models from the teachings of the statistics. Examples of the regression models may include: simple regression, polynomial regression, general linear model, binomial regression, binary regression, logistic regression, discrete choice, multinomial logit, mixed logit, probit, multinomial probit, ordered logit, ordered probit, Poisson multilevel model, fixed effects, random effects, mixed model, nonparametric model, semi-parametric model, robust model, quantile model, isotonic model, principal components model, local mobile, segmented model, errors-in-variables mobile, etc.

The regression analysis may employ any known estimation techniques from the teachings of the statistics. Examples of the estimation techniques may include: least to squares, ordinary estimation, weighted estimation, generalized estimation, partial estimation, total estimation, non-negative estimation, ridge regression, regularized least absolute deviations, iteratively reweighted estimation, Bayesian methods, Bayesian multivariate approach, etc.

In examples in which the reference colorimetric data and respective further colorimetric data are provided as S×R matrices as discussed above, the method may further comprise performing a regression analysis between the matrices associated with the reference substrate and the at least one further substrate. For example, a respective mapping matrix may be calculated from the respective regression analysis for mapping the reference colorimetric data to the respective further colorimetric data and vice versa. The regression analysis may be performed according to the teachings of statistics as discussed above. The mapping matrices may be referred to forward matrices if starting from the reference colorimetric data. The mapping matrices may be referred to reverse matrices if starting from any of the further colorimetric data.

According to some examples, a respective forward matrix may be calculated for each of the at least one further substrate by a nonlinear regression analysis. The nonlinear regression analysis may employ the reference colorimetric data as independent variables and the respective further colorimetric data as dependent variables. Similarly, a respective reverse matrix may be calculated for each of the at least one further substrate by the nonlinear regression analysis, wherein the respective further colorimetric data and the reference colorimetric data are employed as independent variables and as dependent variables, respectively. The nonlinear regression analysis may be performed according to the teachings of the statistics using any of the known techniques as discussed above.

in the examples in which the reference colorimetric data and respective further colorimetric data are used as S×R matrices, a polynomial regression may be performed in which the S×R matrices of the reference colorimetric data and respective further colorimetric data are expanded by at least one of nonlinear terms and crosslinking-terms. For example, a polynomial regression of the second order may be performed, in which square of each of the intensity values are used as nonlinear terms. Additionally or alternatively, the cross-linking terms may be obtained by multiplying any two of the intensity values that are associated with one same color sample.

In specific examples in which 1000 color samples are employed and the reflection spectra are measured at 20 different wavelengths, the measured colorimetric data may be provided as 1000×20 matrices discussed above. In such examples, the expansion by nonlinear terms and cross-linking terms may result in additional 20 square terms and additional 190 crosslinking terms corresponding to 20-choose-2 (or 20C2) for each of the color samples. This results in 1000×230 matrices after performing the expansion. Any suitable expansion of the colorimetric data may be performed instead or in addition in order to determine the estimate functions.

According to some examples, the respective estimate function for each of the at least one further substrate may be determined according to a least square algorithm. For example, a difference of an expansion term of the reference colorimetric data and the respective further colorimetric data may be calculated. A least square of this difference may then be calculated, which may be considered as the requirement or boundary condition for determining the respective forward mapping, which may include a respective forward matrix as discussed above. Additionally or alternatively, any known technique may be used to minimize said difference, for example by applying a norm according to the least absolute deviations regression. Further, a minimum of a penalized version of the least squares cost function may be calculated in order to obtain the estimate function. This may be performed in accordance with at least one of a ridge regression employing a L²-norm penalty and a lasso employing L¹-norm penalty.

In some examples, the forward matrix F may be obtained by solving

min∥[g(W)*F ]−C∥

wherein min ∥ . . . ∥ denotes least square, W (not explicitly used above) denotes the reference colorimetric data as a matrix, C denotes the respective further colorimetric data as a matrix, and g( . . . ) denotes an operation on W. Herein, the notation ∥ . . . ∥ may refer to a L²-norm and correspond to ∥ . . . ∥₂, unless indicated otherwise. The operation g( . . . ) may include at least one of expansion, transformation, combination, analytic or algebraic operation or the like or any combination thereof.

In a specific example, the regression analysis for determining the forward matrix F may be performed by solving

min ∥[P*F]−C∥

wherein P denotes W after an expansion operation. For example, the expansion operation may be a polynomial expansion of the second degree, including at least ones of second degree (nonlinear) terms and cross-linking terms as discussed herein.

According to the Moore-Penrose-inverse or pseudo-inverse, a trivial solution for the forward matrix F may be

F=(P^{T}*P)⁻¹*P^{T}*C

wherein PT denotes transposed matrix of P, and ( . . . )⁻¹ denotes an inverse matrix of ( . . . ). Alternatively or additionally, a solution using known algorithms involving matrix decompositions such as SVD may be used. Additionally or alternatively, a regularization technique may be employed to solve a given regression problem. In such examples, additional constraints may be imposed on the solution, including for example a rank term. For example, the Tikhonov regularization technique may be employed, in which an additive term including a weighted identity matrix is introduced for solving the regression problem.

In the present disclosure, the supervised learning may refer to a machine learning of a function that maps an input to an output based on example input-output pairs, wherein the input and output may refer to any of the reference and the further colorimetric data depending on the individual mapping task. The supervised learning may include an algorithm analyzing training data comprising of a set of training examples. The algorithm may produce an inferred function from the training data. The inferred function may be used for mapping new data.

The supervised learning may be within an approach in accordance with the concept of an artificial neural network. Accordingly, an artificial neural network may be applied to the objective of mapping the reference colorimetric data to the respective further colorimetric data. In the present disclosure, the artificial neural network may refer to computing systems or processes that are configured to learn to perform tasks by considering examples, generally without programmed with task-specific rules. For example, the artificial neural network may automatically generate identifying characteristics from the processed (training) examples.

According to some examples, for each of the at least one further substrate, the respective estimate function may be provided by applying a series of perceptrons, in which at least two different regression models are employed in series. For example, an to output of a preceding estimation or regression may be used as input of a following estimation or regression.

For example, in the supervised learning, the reference may be received as an input and the further colorimetric data may be computed as an output according to non-linear functions of the reference colorimetric data. The non-linear functions may be aggregated into multiple layers, wherein different layers may perform different transformations on their respective inputs. During a corresponding mapping, the input data may be converted from the first layer (i.e. the input layer) through the intermediate layers to the last layer (i.e. the output layer). Each layer may be associated with a regression analysis discussed above. In a specific example, the first and last layers may each perform a linear regression analysis, while the intermediate layers perform a variety of nonlinear regression analysis.

As discussed above, the colors, colorimetry or colorimetric data of the color samples deposited on the reference substrate may be mapped to the corresponding ones of the color samples deposited on the respective further substrate according to the respective forward mapping. Similarly, the colors, colorimetry or colorimetric data of the color samples deposited on any of the further substrate may be mapped to the corresponding ones of the color samples deposited on the reference substrate according to the respective forward mapping. The mapping may also include, or referred to, as characterization or profiling of the respective substrate. As such, a characterization chart may be provided characterizing the appearance of different colors (i.e. colorimetric data) on the differently colored further substrates.

In specific examples where the colorimetric data are provided as matrices, the forward mapping and the reverse mapping may include applying a forward matrix and a reverse matrix, respectively. Once the estimate function for the mapping has been obtained, mapping between the colorimetric data associated with differently colored substrates may be performed by a matrix multiplication. For example, when starting with colorimetric data associated with the reference substrate, applying a selected estimate function (for example a forward matrix F) may allow for a prediction of colorimetric data associated with a corresponding particular colored substrate. When starting from colorimetric data associated with a colored start substrate, a first estimate function for mapping to the colorimetric data associated with the reference substrate and a second estimate function for mapping the colorimetric data to those associated with a colored target substrate may be performed in sequence to provide mapping of the colorimetric data associated with the start substrate to the colorimetric data associated with the target substrate.

Colors different from those of the color samples may be mapped to a given target substrate by means of interpolation. The interpolation may be performed in accordance with the teachings of the statistics. Additionally or alternatively, the mapping of the colors different from the color samples may be estimated in accordance with the known estimation techniques. In particular, the interpolation may be performed if mapping between the colorimetric data is performed by means of lookup-tables. It is understood that performing an interpolation is optional only and, in some examples as described above, the method and system disclosed herein may allow for mapping of the colorimetric data associated with differently colored substrates without interpolation. Additionally or alternatively, mapping of the colorimetric data may be assisted by a training process employing subsampling of the available device space to be used as training data.

Moreover, mapping of colors with respect to any further target substrate having a different color may be determined by means of interpolation. Additionally or alternatively, the mapping of the colors with respect to further target substrates may be estimated by means of estimation techniques as known from the teachings of the statistics.

Using the forward mapping and the reverse mapping may allow for the colorimetric data corresponding to one of the further substrates to be mapped to the colorimetric data corresponding to another one of the further substrates.

According to some examples, the at least one further substrate may comprise a first substrate and a second substrate having a first color and second color, respectively. The first and second colors may be distinct from each other. A set of color samples may be deposited on both the first substrate and the second substrate. First colorimetric data and second colorimetric data may be measured from the set of color samples deposited on the first substrate and the second substrate, respectively.

In addition to the respective estimate function for each of the at least one further substrate as discussed above, a first estimate function may he used to estimate mapping of the first colorimetric data to the reference colorimetric data. A second estimate function may be used to estimate mapping of the reference colorimetric data to the second colorimetric data.

According to such examples, the method may further comprise subsequently applying the first estimate function and the second estimate function to obtain a mapping of the first colorimetric data to the second colorimetric data. Accordingly, the colorimetric data corresponding to the first substrate may be mapped to the colorimetric data corresponding to the second substrate. In this respect, the first substrate and the second substrate may be also referred to as a starting substrate and a target substrate, respectively. This may be used to predict, for example visualize, colors of a given image on differently colored substrates.

According to sonic examples, a colored input image may be received which is to be printed on a particular substrate having a particular color. The particular color may be non-white or colored as discussed above. The particular substrate may be one of the at least one further substrate and may have a particular color. The colors that are used in the received colored image are mapped to colors that will appear on the particular substrate according to the estimate function as discussed above. The estimate function may be determined in any of the above described manner and may be used to estimate the mapping of the reference colorimetric data to the colorimetric data associated with the particular substrate.

The mapping may be used to adapt color settings for a particular printing task, for example to print an input colored image on a colored target substrate. The adapting of the color settings may be performed according to the estimate functions including at least one of the forward mapping and reverse mapping. In the present disclosure, the color settings may refer to internal settings of a particular device to reproduce a colored input image as perceived by the human eye. For example, such a device may be a printing device employing spot colors and process colors, and the color settings of such a printing device may be used to control the deposition of the spot color inks to reproduce colors of the colored input image, i.e. an input color.

Using the forward mapping and the reverse mapping, color settings of a printing device may be modified in accordance with the color of a target substrate (i.e. a further substrate on which an image is to be printed) without requiring extra measurement, characterization or profiling. Hence, the overhead for printing an image on colored substrates may be reduced while providing a satisfactory prediction of the colorimetry of an to image to be printed on the target substrate. In particular, the overhead may be reduced by omitting any extra steps of printing a sample image onto the target substrate, measuring the colorimetry of the printed image predicting the colorimetry of future printouts on that target substrate.

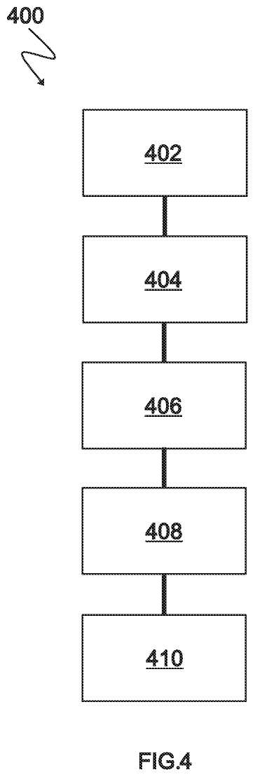

FIG. 4 shows a flow diagram of a method 400 according to a further example. The method 400 may be carried out, at least partially or entirely, by the printing system too discussed with reference to FIG. 1. At 402, a set of color samples is deposited on a near-white reference substrate, on a first non-white substrate and on a second non-white substrate. The near-white reference substrate may be provided as discussed above. In particular, the near-white reference substrate may be near-white textile substrate. The non-white first and second substrates may any of the further substrates as discussed above and have a respective non-white color.

At 404, reflection spectra of the set of color samples deposited on the reference substrate and the first and second substrates are measured. The measurements of the reflection spectra may include the reflectance intensity as discussed above. The reflection spectra may be measured using any of the above described examples. The reflection spectra may be part of the respective colorimetric data as discussed above.

At 406, a reverse function is calculated, wherein the reverse function may be used for mapping the reflection spectra associated with the first substrate to the reflection spectra associated with the reference substrate. In the present disclosure, the expression of the reflection spectra being associated with a substrate may refer to the reflection spectra of the color samples deposited on that substrate. The reverse function may correspond to at least one of the reverse mapping and the reverse matrix discussed above. The reverse function may be determined by at least one of the regression analysis or supervised learning as discussed above.

At 408, a forward function is calculated, wherein the forward function may be used for mapping the reflection spectra associated with the reference substrate to the reflection spectra associated with the second substrate. The forward function may correspond to at least one of the forward mapping and the forward matrix discussed above. The forward function may be determined by at least one of the regression analysis or supervised learning as discussed above.

At 410, the reverse function and the forward function are subsequently applied to estimate mapping of the reflection spectra associated with the first substrate to the reflection spectra associated with the second substrate. Accordingly, it is predicted how the colors from the first substrate would appear if printed on the second substrate.

According to some examples, a display device may be used to render a colored input image according to the aforementioned mapping of colors from the input image to colors that will appear on the particular substrate. This may allow for predicting the printout without actually printing the input image.

According to some examples, it is determined whether the colors to appear on the particular substrate according to the estimate function are in accordance with the received colored image in terms of colorimetry. As discussed above, the estimate function may be used to estimate the mapping of the colors from an input image to colors that would appear on the particular substrate if printed thereon. This may reduce the overhead caused by additional measurements and examination.

According to some examples, it is determined whether the colors to appear on the particular substrate according to the estimate function are inside a gamut of a printing device. Accordingly, the examples facilitate the assessment whether or not an input image may be reproduced in a satisfactory manner.

The examples of a method and system described herein allow for predicting the appearance of a set of colors, for example of an input image, on a colored target substrate. Further, the technique disclosed herein may allow for predicting the change of the colorimetry of the input image on differently colored substrates. This may facilitate the management of color settings of a device for printing the input image on a target colored substrate. Accordingly, the color settings may be adjusted individually in accordance with the respective image and the color of the respective substrate. Moreover, an accurate prediction of the color reproduction may be provided.

Moreover, the examples of a method and system disclosed herein may allow for determining whether or not the colors of the input image to be printed on a target colored substrate will be reproducible by the device for printing the input image.

According to some examples, the examples of a method and system of the present disclosure allow for calculating a model from an initial measurement and a corresponding initial characterization of a particular colored substrate. The number of printing and measurement for the purpose of characterization and profiling of a particular colored substrate may be reduced to a single sample substrate. As such, the subject matter of the present disclosure may reduce the overhead for characterization and profiling for a given colored substrate.

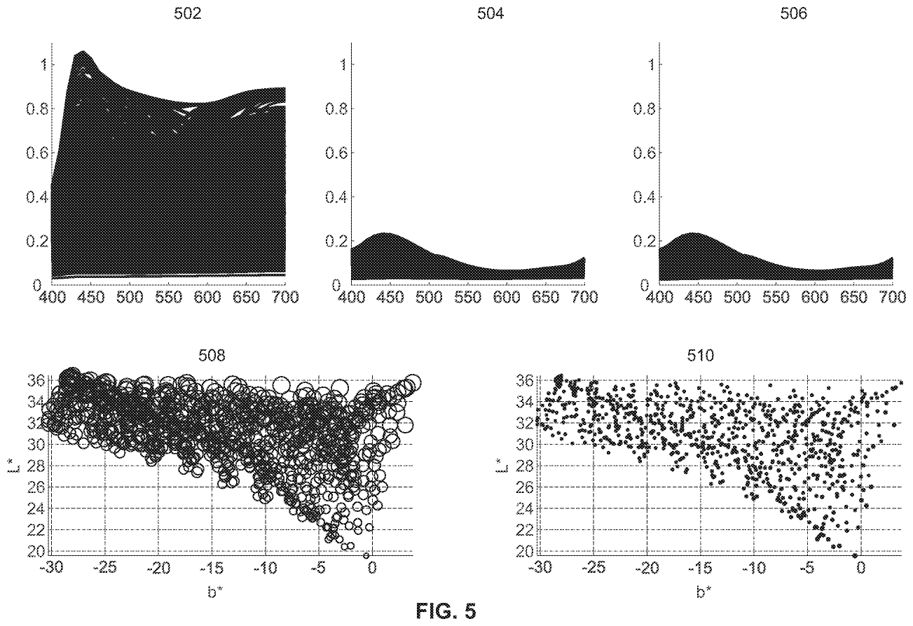

FIG. 5 shows schematic diagrams of colorimetric data of a set of color samples deposited on a white reference substrate and on a blue substrate. Diagrams 502 and 504 show reflectance intensities of a set of color samples measured in the visible wavelength range between 400 nm and 700 nm. Diagram 502 shows the measurement results on a white substrate. Diagram 504 shows the measurement results on a blue substrate.

As shown in diagram 502, the reflectance intensities of the color samples are widely spread over the entire visible wavelength range when deposited on a white substrate. In comparison, as shown in diagram 504, the reflectance intensities as a whole are decreased when deposited on a blue substrate. In addition, the reflectance intensities, i.e. the colors, of the color samples are shifted towards and concentrated at blue and blueish colors at approx. 450 nm when deposited on the blue substrate.

Diagram 506 shows estimated colorimetric data of the same color samples on a blue substrate that are obtained from the mapping according to the examples as discussed above. In particular, the estimated results shown in diagram 506 are obtained by performing a polynomial expansion including cross-linking terms and nonlinear terms of the second degree and solving the least square term (min∥ . . . ∥) as discussed above. The results shown in the diagram 506 in comparison to the diagram 504 demonstrate that the examples as discussed herein provide an accurate estimation of the mapping of the colorimetric data between differently colored substrates.

This finding is further supported by the results shown in diagrams 508 and 510, in which the color deviation of each of the color samples between the white substrate and the blue substrate are depicted in a two-dimensional L*a* color space. In the diagrams 508 and 510, each circle represents a single color sample, and the diameter of the circles depicts the deviation of the respective color between the white and blue substrates. The diagram 508 shows the color deviation without performing the mapping according to the present disclosure.

The diagram 510 shows the color deviation after color adjustment performed according to the mapping as disclosed herein. For example, the color adjustment may to include the adjustment of the color settings of a printing device as discussed above. The smaller circles in the diagram 510 when compared to the comparably larger circles in the diagram 508 indicate that the deviation of colors from printing differently colored substrates have been successfully reduced by performing the mapping according to the present disclosure. Accordingly, the mapping according to the present disclosure allow for reducing the change and distortion of colors that may occur when printing on differently colored substrates.

1. A method, comprising:
measuring reference colorimetric data of a set of color samples deposited on a reference substrate, wherein the reference substrate has a reference color;
measuring further colorimetric data of the set of color samples deposited on at least one further substrate having a respective further color distinct from the reference color;
for each of the at least one further substrate, applying a respective estimate function to estimate at least one of:
mapping of the reference colorimetric data to the respective further colorimetric data; and
mapping of the respective further colorimetric data to the reference colorimetric data.

2. The method of claim 1,
wherein at least one of the reference colorimetric data and the respective further colorimetric data include at least one of the following: reflectance spectra, tristimulus values, transmittance spectra, and relative irradiance spectra, spectral power distributions.

3. The method of claim 1, wherein
the respective estimate function is provided by applying at least one of a regression analysis and supervised learning.

4. The method of claim 1, wherein the reference colorimetric data and respective further colorimetric data each contain reflectance intensities measured at distinct wavelengths within a visible range, wherein the method further comprises:
providing the reference colorimetric data and respective further colorimetric data as SYR matrices, in which a first dimension S represents the color samples, and a second dimension R represents the distinct wavelengths at which the reflectance intensities are measured,
performing a regression analysis between the matrices associated with the reference substrate and the at least one further substrate.

5. The method of claim 4,
wherein the regression analysis is a polynomial regression, in which the S×R matrices of the reference colorimetric data and respective further colorimetric data are expanded by at least one of nonlinear terms and crosslinking-terms.

6. The method of claim 1, wherein, for each of the at least one further substrate:
a respective forward matrix is calculated by a nonlinear regression analysis employing the reference colorimetric data as independent variables and the respective further colorimetric data as dependent variables, and
a respective reverse matrix is calculated by the nonlinear regression analysis employing the respective further colorimetric data as independent variables and the reference colorimetric data as dependent variables.

7. The method of claim 1,
wherein, for each of the at least one further substrate, the respective estimate function is provided by applying a series of perceptions, in which at least two different regression models are employed in series.

8. The method of claim 1,
wherein, for each of the at least one further substrate, the respective estimate function is determined according to a least squares algorithm.

9. The method of claim 1,
wherein the a least one further substrate comprises a first substrate and a second substrate having a first color and second color, respectively, that are distinct from each other,
wherein first colorimetric data and second colorimetric data are measured from the set of color samples deposited on the first substrate and the second substrate, respectively,
wherein a first estimate function estimates mapping of the first colorimetric data to the reference colorimetric data,
wherein a second estimate function estimates mapping of the reference colorimetric data to the second colorimetric data,
wherein the method further comprises subsequently applying the first estimate function and the second estimate function to obtain a mapping of the first colorimetric data to the second colorimetric data.

10. The method of claim 1, further comprising:
receiving a colored image to be printed on a particular substrate having a particular color; and
providing a mapping of colors used in the received colored image to colors to appear on the particular substrate according to the estimate function estimating the mapping of the reference colorimetric data to the colorimetric data associated with the particular substrate.

11. The method of claim 10, further comprising at least one of the following:
by a display device, rendering the colored image according to the mapping of colors used in the received colored image to colors to appear on the particular substrate;
determining whether the colors to appear on the particular substrate according to the estimate function are in accordance with the received colored image in terms of colorimetry; and
determining whether the colors to appear on the particular substrate according to the estimate function are inside a gamut of a printing device.

12. The method of claim 1,
wherein the reference substrate is a white substrate or a near-white substrate, and
wherein each of the at least one further substrate including any of the following: red, green, blue, cyan, magenta, yellow, brown and orange.

13. The method of claim 1,
wherein the color samples are predefined halftone colors available to a printing device.

14. A method, comprising:
depositing a set of color samples on a near-white reference substrate;
depositing the set of color samples on an first non-white substrate;
depositing the set of color samples on an second non-white substrate;
measuring reflection spectra of the set of color samples deposited on the reference substrate and the first and second substrates;
computing a reverse function for mapping the reflection spectra associated with the first substrate to the reflection spectra associated with the reference substrate;
computing a forward function for mapping the reflection spectra associated with the reference substrate to the reflection spectra associated with the second substrate; and
subsequently applying the reverse function and the forward function to estimate mapping of the reflection spectra associated with the first substrate to the reflection spectra associated with the second substrate.

15. A printing system, comprising:
a deposition device to deposit a set of color samples on a reference substrate having a reference color and on further substrates, the further substrates having colors distinct from one another and distinct from the reference color;
a measurement device to measure colorimetric data of the color samples deposited on the reference substrate and on the further substrates;
a computing device to provide, for each of the further substrates, a respective estimate function to estimate at least one of:
mapping of reference colorimetric data to respective further colorimetric data; and
mapping of the respective further colorimetric data to the reference colorimetric data.
